(19) United States
(12) Patent Application Publication
(10) Pub. No.: US 2010/0262560 A1
(43) Pub. Date: Oct. 14, 2010

(54) METHOD AND SYSTEM FOR ASSESSING APPLICATION PORTFOLIO

(76) Inventors: Subramanyam Krishna Murthy, Diamond Bar, CA (US); Ashish Kumar, Gurgaon (IN); Sushil Kumar Tripathj, Searasatha (IN)

Correspondence Address: Geoffrey Gelman, 14 Berkeley Pl, #3, Brooklyn, NY, 11217, US

(21) Appl. No.: 12/543,505

(22) Filed: Aug. 19, 2009

(30) Foreign Application Priority Data
Apr. 8, 2009 (IN) 918/CHE/2009

(51) Int. Cl. G06Q 40/00; G06N 5/02; G06F 3/048; G06F 17/30

(52) U.S. Cl. 705/36 R; 706/46; 715/760; 707/E17.044; 707/E17.017

(57) ABSTRACT

A web based method and system for assessing client portfolio is disclosed. Assessing client portfolio of the client comprises checking whether the client portfolio maps to the application needs of the client. An assessment model is generated to assess the client portfolio. Inputs regarding business domains and strategy of the client is received and based on the inputs the assessment model is generated. Thereafter assessment score of the client is calculated based on the client inputs and modifications for the assessment model. If the assessment score of the client is below a threshold limit, the client is prompted to update his or her client portfolio.

The present application claims the benefit of priority of the following foreign patent application: India Patent Application No. 918/CHE/2009, filed Apr. 8, 2009, entitled “METHOD AND SYSTEM FOR ASSESSING APPLICATION PORTFOLIO”, the entirety of which is incorporated by reference herein.

### FIELD OF INVENTION

The present invention relates to the field of assessing application needs of a client and more specifically to the field of assessing client portfolio.

### DEFINITION

Client: A client is an individual person or a business entity.
Domain: Domain is a field or industry related to the client, for example, software domain, investment domain, management domain and the like.
Client portfolio: Client portfolio, for a particular domain, is a set of applications and standards utilized by a client. For example client portfolio for IT domain may comprise without limitation, set of information technology (IT) applications and software; client portfolio for investment domain may comprise without limitation stocks & shares, investments made by client; client portfolio for standards domain may comprise without limitation security, safety, process documentation, training standards followed by the client; client portfolio for HR domain may comprise without limitation resumes of potential candidates for a job offered by the client and the like.
Assess OnDemand: It is a set of services provided to the client. The services may comprise without limitation, assessing a particular client portfolio, suggesting improvements in the client portfolio, helping the client in building a comprehensive client portfolio, planning and initiating projects for the client and the like.
Assessment model: Assessment model, for a client portfolio, comprises assessment variables and weights assigned to each assessment variable. Assessment variables include questions based on business domains and strategy of the client. Assessment model is used to assess the client portfolio. The assessment model requires inputs from the client for assessing the client portfolio. Inputs include, for example, answers to the assessment variables, instructions for adding, removing or editing the assessment variables, instructions for modifying weights assigned to the assessment variables and the like.
Completed modified assessment model: Modified assessment model is the assessment model which has been modified based on the inputs provided by the client. A completed modified assessment model is the modified assessment model completely filled by the client.
Registration information: Registration information of the client is the information which the client provides regarding his business domains and strategy, for registering to the Assess OnDemand. Registration information may comprise without limitation, company name, company background, business domains of the client and the like.

### BACKGROUND

In today's fast growing business environment, applications and standards such as software, hardware applications, security, safety, process documentation standards and the like, have become indispensable for business entities. One of the major reasons for increasing use of these applications and standards is to enable smooth functioning of the business entities and for increasing their efficiency in delivering results. Different domains require a different set of applications and standards to be followed. For example, in internet domain, business entities seek to provide on-line services which require specific IT applications. Another example may be of information sensitive industry where it is crucial to keep a check on information transfer in and out of the industry. Thus it is crucial to find out if the IT security of the industry is upto standards. If the IT security is not up to the standards then it is desirable to find the IT applications for bringing the IT security upto standards.

Application needs of a client can be dynamic, changing with the changing scope of business of the client. Thus a regular assessment of client portfolio is required so as to ensure that the client portfolio is in line with the business strategy of the client. Prior art teaches assessment systems that assess a client portfolio.

US Patent Publication application 20020194052 titled “Method and system for analyzing application needs of an entity”, assigned to International Business Machines Corporation, discloses a system and method for analyzing an entity's application portfolio based on the business strategy of the entity.

US Patent Publication application 20030208427 titled “Automated investment advisory software and method”, discloses an auto assessing system wherein questions and disparate variables are extracted from a database to form an assessing model which is presented to client.

However, it may happen that the assessing system, for a particular client domain, is not comprehensive and does not cover the crucial aspects of the business domain of the client. In such cases feedback provided by a client play an important role in making the assessing system comprehensive and exhaustive in assessing the client portfolio.

Prior art teaches methods that allow for improvement in performance of an assessment system based on feedback provided by clients who are using the system. However, such feedback is typically provided after the assessment is completed and the output is not up to the expectations of the client. Thus a second assessment might be required after the feedback is incorporated. This results in time and monetary loss for the client.

In light of the above mentioned prior arts, there exists a need for an assessment model which removes the drawbacks of the prior art.

### SUMMARY

A web based method for assessing a client portfolio of a client is disclosed. An assessment model is generated based on inputs provided by the client regarding business domains and strategy of the client. The assessment model comprises assessment variables and weights assigned to the assessment variables. Inputs are received from the client for the assessment variables and for modifying the assessment model. Thereafter, assessment model is modified based on the instructions received from the client for modifying the assessment model. When the client has filled the assessment model and submitted it, completed modified assessment model is received. Assessment score of the completed modified assessment model is then calculated and the assessment score is conveyed to the client.

A web based system for assessing the client portfolio of the client is disclosed. An assessment model is generated by a rules engine based on the business domains and strategy of the client. The assessment model is provided to the client through a client interface residing on a client computer. For example, the client interface could be a web interface residing on the client computer. Inputs are received from the client for the assessment variables by the rules engine. Client may provide instructions to modify the assessment model. For example, client may provide instructions to add, remove or edit the assessment variables. These instructions are received by the rules engine. Thereafter rules engine verifies from a database, if the modifications instructed by the client are allowed by administrator of the system. Further, the assessment model is modified by the rules engine and a completed modified assessment model, completely filled and submitted by the client is stored in the database. Thereafter, the completed modified assessment model is received by a calculation engine from the database. The calculation engine calculates the assessment score of the client portfolio and conveys the assessment score to the client. In case, the assessment score of the client is below a threshold limit, the client is prompted to update his or her client portfolio in order to meet his or her application needs.

### BRIEF DESCRIPTION OF THE DRAWINGS

FIG. 1 is a schematic illustrating an assessment environment in accordance with an embodiment of the invention;

FIG. 2 is a schematic illustrating an assessment engine in accordance with an embodiment of the invention;

FIG. 3 is a flow diagram illustrating a method for assessing client portfolio in accordance with an embodiment of the invention; and

FIG. 4 is a flow diagram illustrating a detailed method for assessing client portfolio in accordance with an embodiment of the invention.

### DETAILED DESCRIPTION

In the following description, for the purposes of explanation, specific details are set forth in order to provide a thorough understanding of the invention. However, it will be apparent that the invention may be practiced without these specific details. Various aspects and features of example embodiments of the invention are described in more detail hereinafter.

An embodiment of the present invention or any of its components may be embodied in the form of a processing machine. Typical examples of a processing machine include a computer, a programmed microprocessor, an integrated circuit, and other devices or arrangements of devices that are capable of implementing the steps of the method of the current invention. The processing machine executes a set of instructions that are stored in one or more storage elements, in order to process input data. The storage elements may also hold data or other information as desired. The storage element may be in the form of an information destination or a physical memory element present in the processing machine. The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine. A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the internet or any client server models that enable communication. Such communication technologies may use various protocols such as TCP/IP, UDP, ATM or OSI.

A method and system for assessing a client portfolio is disclosed, wherein the client may be an individual person or a business entity.

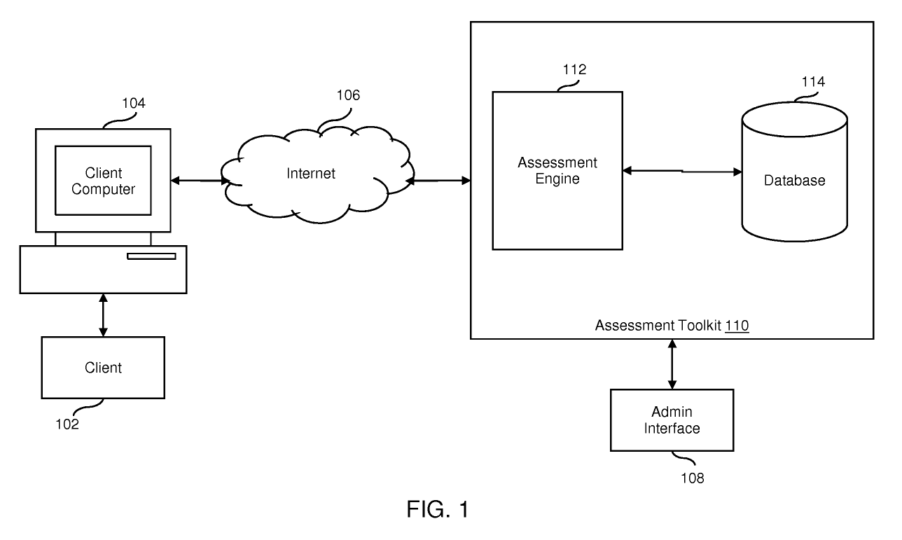

FIG. 1 is a schematic illustrating assessment environment 100 in accordance with an embodiment of the invention. Assessment environment 100 includes client 102, client computer 104, network 106, admin interface 108, and assessment toolkit 110. Assessment toolkit 110 includes assessment engine 112 and database 114. Upon receiving a request from client 102 for assessment of a particular client portfolio, assessment toolkit 110 generates assessment model for the particular client portfolio. Assessment toolkit 110 is connected to client computer 104 through network 106. Client 102 may access the assessment model through an interface such as, a web browser residing on client computer 104. Network 106 can be a local area network, wide area network, or the internet. It must be apparent to any person skilled in the art that the invention is not limited to network alone. Any gateway wherein client 102 can interact with another system such as a mobile telecommunication system, an interactive television system and the like can be used without deviating from the scope of the invention. Client 102 provides inputs for the assessment model through the interface. Assessment toolkit 110 receives inputs and generates an assessment score for the assessment model. The assessment score is a reflection of the completeness of client portfolio.

Assessment engine 112 of assessment toolkit 110 generates the assessment model for client 102 based on the business domains and strategy of client 102. Client 102 may have to register with assessment engine 112 for assessing a client portfolio. Registration information of client 102 comprises without limitation, name of company of client 102, industrial domain of the company and the like. Assessment engine 112 stores assessment models, registration information of client 102, and the like in database 114.

Admin interface 108 is a visual editor provided to administrator of assessment toolkit 110. Admin interface 108 enables the administrator to modify the assessment models, activate the assessment model to be presented to client 102 and to grant permissions to client 102 for editing the assessment model. In an embodiment, admin interface 108 is a web interface, enabling the administrator to remotely access assessment toolkit 110. In an embodiment of the invention, code for admin interface 108 is written in .Net using C# as the programming language.

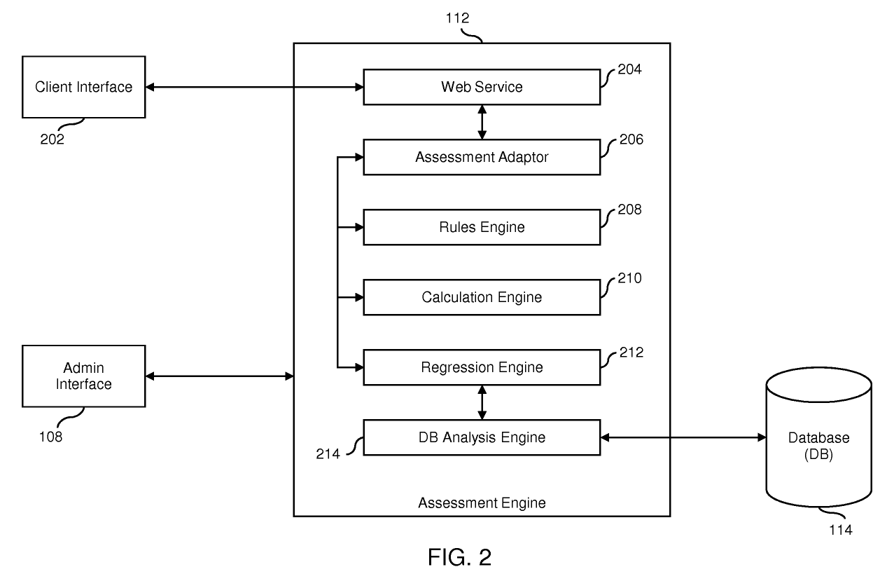

FIG. 2 is a schematic illustrating assessment engine 112 in accordance with an embodiment of the invention. Assessment engine 112 includes web service 204, assessment adaptor 206, rules engine 208, calculation engine 210, regression engine 212 and database (DB) analysis engine 214. Web service 204 hosts the assessment model on a web portal. Further, web service 204 enables transfer of information between client interface 202 and assessment engine 112. Client interface 202 resides on client computer 104. Inputs are received from client computer 104 in XML format and are transferred to assessment adaptor 206 via web service 204. Assessment adaptor 206 interprets the inputs, converts the inputs from XML to appropriate data structures and transfers the appropriate data structures to rules engine 208, calculation engine 210 or regression engine 212 based on the nature of inputs. The appropriate data structures includes without limitation arrays, matrices, vectors and the like. The data structures are readable by rules engine 208, calculation engine 210 and regression engine 212.

In an embodiment of the invention, rules engine 208, calculation engine 210, regression engine 212 and DB analysis engine 214 are developed in java.

In an embodiment of the invention, codes for client interface 202 and web service 204 are written in .Net using C# as the programming language.

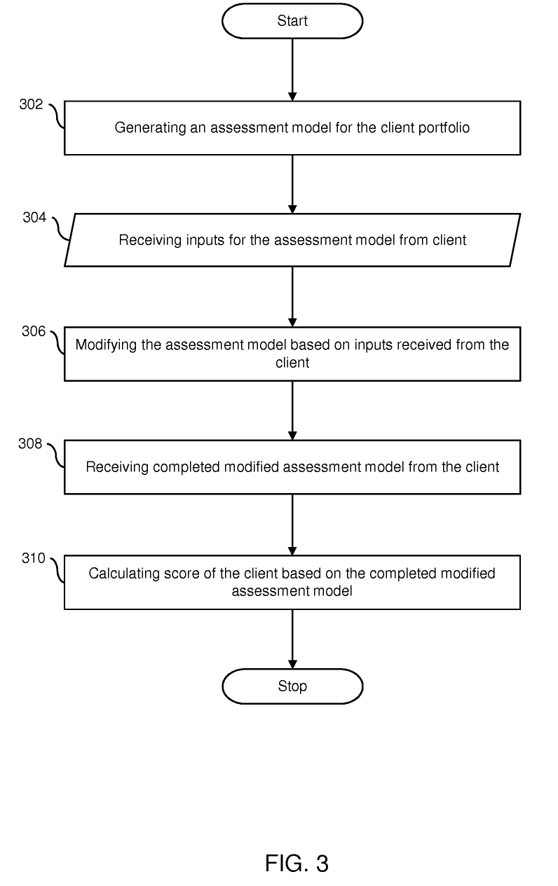

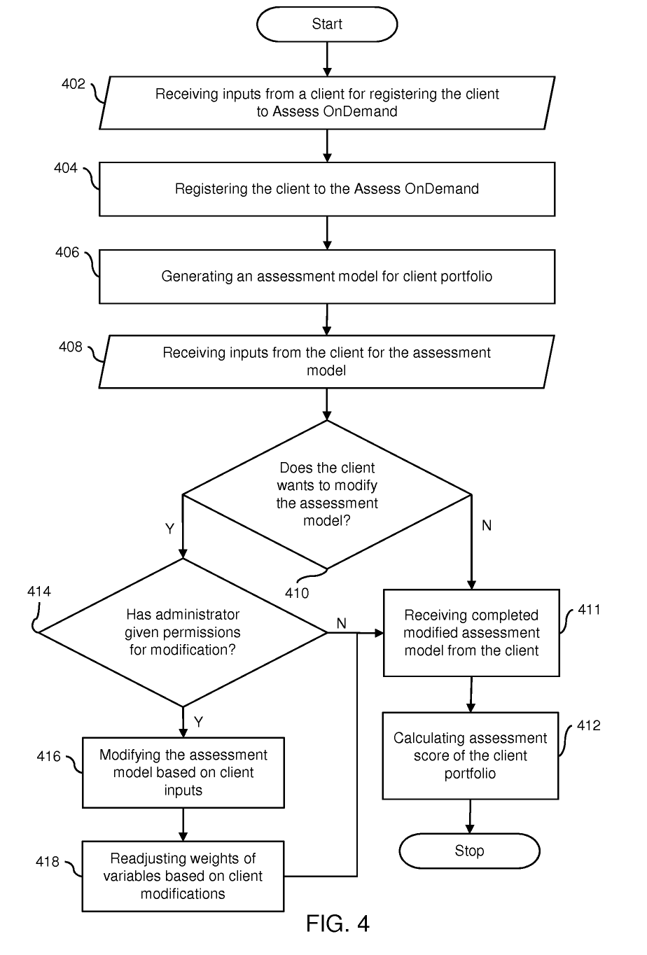

Rules engine 208 generates the assessment model including assessment variables and their respective weights by applying a plurality of conditions and rules. According to an embodiment, weights are assigned using fuzzy logic. The process of generating a model has been described in detail in conjunction with FIG. 3 and FIG. 4. The assessment variables may include, without limitation, linguistic variables, Boolean variables, subjective variables and the like. The assessment variables are based on the business domains and strategy of client 102. Upon receiving instructions from client 102 to modify the assessment model, rules engine 208 verifies whether the administrator has given permissions for modifying the assessment model. Based on the verification, rules engine 208 modifies the assessment model and may reassign the weights to the assessment variables at real time.

Calculation engine 210 receives completed modified assessment model from client computer 104 through assessment adapter 206. Calculation engine 210 calculates the assessment score of the completed modified assessment model by applying a plurality of math functions on the inputs provided by client 102 for the assessment variables and their respective weights. Score calculation is discussed in detail in conjunction with FIG. 3 and FIG. 4.

Regression engine 212 analyses data stored in database 114 and extracts weights and other statistical data corresponding to the assessment variables of the assessment model created by rules engine 208. The analyses include studying of a plurality of assessment models, stored in database 114, which are relevant to business domains and strategies of client 102. Studying includes conducting a similarity check between the assessment variables in the plurality of assessment models and the assessment variables in the assessment model created for client 102. Regression engine 212 then extracts weights and other statistical data of the assessment variables which are associated with the plurality of assessment models. Based on the extracted weights and other statistical data, the weights of the assessment variables in the assessment model created for client 102, are decided. Further regression engine 212, may identify additional assessment variables in the plurality of assessment models which may be added to the assessment model created for client 102. Corresponding weights and other statistical data corresponding to each such additional assessment variables is also extracted from database 114 by regression engine 212.

DB analysis engine 214 extracts data from database 114 and converts the data to desired format as required by regression engine 212. For example, in case data is stored in binary format in database 114, DB analysis engine 214 will convert the data to the appropriate data structures and transfer the appropriate data structures to regression engine 212. DB analysis engine 214 may also transfer data from database 114 to rules engine 208 and calculation engine 210, when required.

FIG. 3 is a flow diagram illustrating a method for assessing client portfolio in accordance with an embodiment of the invention.

After receiving a request from client 102 for assessing her client portfolio, an assessment model is generated, at step 302, by rules engine 208 of assessment engine 112. The assessment model includes assessment variables and weights assigned to each assessment variable.

According to an embodiment, the assessment variables are predefined by the administrator. The predefined assessment variables are also assigned weights by the administrator. The weights may be based on previous assessment models stored in database 114.

In an embodiment, assessment variables of the assessment model are defined by rules engine 208 based on previous information received from client 102 regarding the business domains and strategies of client 102. For example, based on such previous information stored in database 114, business performance, IT security, backup & recovery and the like may be defined as assessment variables for assessing client portfolio of client 102 related to management domain.

After the assessment variables have been defined, the administrator, in an embodiment, decides the assessment variables to be included in the assessment model and the respective weights for the assessment variables through admin interface 108. In another embodiment, rules engine 208 decides the assessment variables to be included in the assessment model based on relevant assessment models. The relevant assessment models may include assessment models previously generated for client 102 and also assessment models generated for other clients having business domains and strategy similar to business domains and strategy of client 102. Further, the weights of the assessment variables are decided by rules engine 208 based on the weights of the assessment variables in the relevant assessment models.

In an embodiment, the administrator may change the weights assigned to the assessment variables by rules engine 208. For example, an assessment variable may be given a weight of 8% by rules engine 208. If the administrator feels that the weight is not appropriate, and it should be 10% rather than 8%, then the administrator may modify the weight to 10%.

In an embodiment, the assessment model may be extracted from database 114 by regression engine 212, wherein client 102 is already registered to the Assess OnDemand.

In another embodiment, the administrator may provide a previously stored assessment model to client 102 instead of a newly generated assessment model.

In an embodiment, regression engine 212 provides client 102 with the assessment model activated by the administrator.

In another embodiment, in case more than one assessment models are stored for client 102 in database 114, regression engine 212 will decide which assessment model to present to client 102.

Client 102 may access the generated assessment model through client interface 202.

At step 304, rules engine 208 receives inputs for assessment model from client 102. Inputs include, for example, instructions for adding, removing or editing the assessment variables; instructions for modifying the weights assigned to the assessment variables and the like. In an embodiment client 102 may add a variable to the assessment model and specify a set of rules for assigning the weights to the added variable. The set of rules may include without limitation the range of weights to be assigned to the added variable based on the input of client 102 for that added variable. For example, suppose client 102 wants to assess a laptop. The assessment model is generated for assessing the laptop. The assessment model comprises 3 assessment variables namely, processor, CPU usage, and hard disk memory. Client 102 may add GPU memory as another variable to the assessment model. Similarly, client 102 may specify weights to the added variable and existing variables. Client 102 may also specify a set of rules for the weights. For example, if the processor speed is more that 1.4 GHz, assign a high weight to the processor variable. Also if the processor speed is less than 1 GHz, assign a low weight to the processor variable. Inputs may also include responses for assessment variables. For example, client 102 may specify ‘1.5 GHz’ against the assessment variable ‘processor speed’.

In an embodiment in case client 102 chooses to add another assessment variable in the assessment model, client 102 is presented with a list of variables related to the domain of client 102. Client 102 may choose to add an assessment variable from the list of variables. In another embodiment client 102 may add a new assessment variable to the assessment model presented to client 102, which is not in the list of variables.

At step 306, rules engine 208 modifies the assessment model based on the inputs received from client 102. In an embodiment, rules engine 208 incorporates the modifications suggested by client 102 and also does other modifications. For example, client 102 may have suggested modifications only in the assessment variables. However, rules engine may also modify the weights of some assessment variables on the basis of the changes in the assessment variables.

The modified assessment model is again presented to client 102 through client interface 202 in case the model is incomplete.

At step 308, completed modified assessment model is received from client 102 by rules engine 208. The completed modified assessment model is the assessment model completely filled by client 102. Rules engine 208 then assigns an individual score to each assessment variable in the completed modified assessment model. In an embodiment, individual score of the assessment variables are decided using fuzzy logic by rules engine 208. In another embodiment of the invention, regression engine 212 assigns individual scores to each assessment variable in the completed modified assessment model. Regression engine 212 analyzes a plurality of assessment models, stored in database 114, which are relevant to business domains and strategies of client 102 and decides the individual scores for each of the assessment variables. In another embodiment of the invention, the administrator could decide the individual score of the assessment variables. Further the administrator may modify the individual scores of the assessment variables assigned by rules engine 208.

Rules engine 208 provides information regarding individual scores and weights to calculation engine 210.

At step 310, assessment score of client 102 is calculated by calculation engine 210. The assessment score is based on individual score of client 102 for each assessment variable and the weights assigned to each assessment variable. For example, the score given to an assessment variable called ‘number of computers’ may be twenty and the weight assigned to ‘number of computers’ may be ten percent, then the contribution of ‘number of computers’ assessment variable in the assessment score is two. Similarly contribution of each assessment variables is calculated and combined to get the assessment score.

The assessment score is compared with a threshold assessment score for that assessment model, wherein value of the threshold assessment score is different for different client portfolios and assessment models. An assessment score below the threshold score indicates that client 102 needs to update his or her client portfolio in order to meet his or her application needs. In an embodiment of the invention, a range of threshold assessment scores may be assigned to a particular client portfolio for deciding rating of the client portfolio. For example, suppose the assessment score of client 102 lies in the range of 5-10, the rating assigned to client 102 would be ‘weak’. In an embodiment of the invention, a plurality of ratings could be assigned to the client portfolio of client 102, including but not limited to excellent, good, average, weak and the likes, based on the threshold assessment score range in which the assessment score of client 102 lies.

In an embodiment, the threshold assessment score may be decided by the administrator. In another embodiment of the invention, the threshold assessment score of client 102 may be decided by rules engine 208 based on previous relevant assessment models. The assessment score is conveyed to client 102 by calculation engine along with an analysis. For example, in case client 102 gets ten as his or her assessment score, and the threshold assessment score is 15, client 102 may be informed that his or her client portfolio is ‘weak’ and should be upgraded.

FIG. 4 is a flow diagram illustrating a detailed method for assessing client portfolio of client 102, in accordance with an embodiment of the invention.

At step 402, domain inputs are received from client 102 regarding the business domains and strategy of client 102, to register client 102 to the Assess OnDemand. The domain inputs from client 102 are transferred to DB analysis engine 214 via web service 204 and assessment adaptor 206 respectively. Thereafter the domain inputs are converted to required format by DB analysis engine 214 and stored in database 114. Regression engine 212 extracts the domain inputs received from client 102 from database 114 and processes the domain inputs. After regression engine 212 has received all the required domain inputs from client 102, client 102 is registered to the Assess OnDemand at step 404, by regression engine 212.

After registering client 102 to the Assess OnDemand, the registration information of client 102 is stored in database 114 by regression engine 212 via DB analysis engine 214 which converts the registration information to required format. Thereafter, rules engine 208 receives a request from client 102 for assessing the client portfolio via client interface 202, web service 204 and assessment adaptor 206 respectively. Further, rules engine 208 generates an assessment model for client 102 at step 406.

Thereafter client 102 is provided the assessment model. At step 408, rules engine 208 receives inputs from client 102 for the assessment variables of the assessment model.

The administrator may allow client 102 to modify the assessment model. At step 410, client 102 is given the option of modifying the assessment model by rules engine 208. In case client 102 does not modify the assessment model, the completed modified assessment model is received by calculation engine 210 at step 411. Thereafter, the assessment score for the client portfolio is calculated by calculation engine 210, at step 412.

In case client 102 wants to modify the assessment model, rules engine 208 receives instructions for modifying the assessment model from client 102. Thereafter, rules engine 208 verifies whether client 102 has permissions to modify the assessment model at step 414. In case the administrator has granted permissions to enable client 102 to edit the assessment model, the assessment model is modified by rules engine 208 based on the instructions received from client 102, at step 416. In an embodiment, administrator may grant permission to client 102 to edit a plurality of the assessment variables of the assessment model. For example, the administrator may allow client 102 to add, remove or edit the assessment variables for infrastructure domain.

In an embodiment, the administrator may grant client 102, permission to view and edit weights assigned to the assessment variables of the assessment model. For example, ‘age of computers’ assessment variable may be assigned a weight of ten percent in the assessment model, even though for business domain of client 102, ‘age of computers’ is not a significant assessment variable. Therefore client 102 may reduce the weight of ‘age of computers’ assessment variable to a lesser value in accordance to the application needs of the business domain of client 102.

At step 418, the weights of the assessment variables are reassigned based on the modifications made by client 102 in the assessment model. In an embodiment, client 102 may add an assessment variable to the assessment model and specify the weight of the added assessment variable, the weights of other assessment variables will be adjusted accordingly by rules engine 208. In another embodiment client 102 may remove an assessment variable from the assessment model; the weights of remaining assessment variables will be normalized accordingly.

When the weights have been assigned to all the assessment variables, the completed modified assessment model is received by calculation engine 210 at step 411. Thereafter, the assessment score of the client portfolio of client 102 is calculated by calculation engine 210, at step 412. Recommendations are provided to client 102 regarding updating of the client portfolio based on the assessment score by domain experts. Wherein, domain experts are people expert in the business domains and strategy of client 102. Further, the domain experts help client 102 in developing a strategy for initiating projects to map the client portfolio with the application needs of client 102. Thereafter, the domain experts help client 102 to decide whether the project is to be off-shored, near shored and the like. Projects are prioritized and project requirements are identified for modifying the client portfolio of client 102.

While example embodiments of the invention have been illustrated and described, it will be clear that the invention is not limited to these embodiments only. Numerous modifications, changes, variations, substitutions and equivalents will be apparent to those skilled in the art without departing from the spirit and scope of the invention.

What is claimed is:

1. A method for assessing a client portfolio of a client, the method comprising:
a) generating an assessment model for the client portfolio;
b) receiving inputs for the assessment model from the client;
c) modifying, at run-time, the assessment model based on the inputs received from the client;
d) receiving completed modified assessment model from the client; and
e) calculating score of the client portfolio based on the completed modified assessment model.

2. The method of claim 1, wherein the step of generating the assessment model comprises assigning weights to assessment variables used for generating the assessment model.

3. The method of claim 1, wherein the step of receiving inputs comprises receiving answers to the questions specific to the business domain and strategy of the client.

4. The method of claim 1, wherein the step of receiving inputs comprises receiving modification inputs.

5. The method of claim 4, wherein the step of receiving modification inputs comprises receiving instructions for adding or removing the assessment variables.

6. The method of claim 4, wherein the step of receiving modification inputs comprises receiving instructions for modifying the weights assigned to the assessment variables.

7. A computer program product for use with a computer, the computer program product comprising a computer usable medium having a computer readable program code embodied therein for assessing a client portfolio of a client, the computer readable program code being executable by the computer for causing the computer to perform the steps of:
a) generating an assessment model for the client portfolio;
b) receiving inputs for the assessment model from the client;
c) modifying, at run-time, the assessment model based on the inputs received from the client;
d) receiving completed modified assessment model from the client; and
e) calculating score of the client portfolio based on the completed modified assessment model.

8. The computer program product of claim 7, wherein the step of generating the assessment model comprises assigning weights to assessment variables used for generating the assessment model.

9. The computer program product of claim 7, wherein the step of receiving inputs comprises receiving answers to the questions specific to the business domain and strategy of the client.

10. The computer program product of claim 7, wherein the step of receiving inputs comprises receiving modification inputs.

11. The computer program product of claim 10, wherein the step of receiving modification inputs comprises receiving instructions for adding or removing the assessment variables.

12. The computer program product of claim 10, wherein the step of receiving modification inputs comprises receiving instructions for modifying the weights assigned to the assessment variables.

13. A system for assessing client portfolio of a client, the system comprising:
a) a rules engine, the rules engine configured to:
i. generate an assessment model for the client portfolio;
ii. receive inputs for the assessment model from the client; and
iii. modify, at run-time, the assessment model based on the inputs received from the client;
b) a calculation engine, the calculation engine configured to:
i. receive completed modified assessment model from the client; and
ii. calculate score of the client portfolio based on the completed modified assessment model;
c) a regression engine, the regression engine configured to:
i. analyze inputs provided by the client regarding business domain and strategy of the client; and
ii. analyze the assessment models stored in a database.

14. The system of claim 13 further comprises
a) a web service, the web service configured to host the assessment model on a web portal;
b) an assessment adaptor, the assessment adaptor configured to analyze inputs received from the client;
c) a DB analysis engine, the DB analysis engine configured to transform data into required format;
d) a database, the database configured to store assessment models;
e) a user interface; and
f) an admin interface.

15. The system of claim 14, wherein the user interface is a web page.

16. The system of claim 14, wherein the admin interface is a visual editor.

17. The system of claim 14, wherein the admin interface is a web page.
